(19) United States
(12) Patent Application Publication
(10) Pub. No.: US 2020/0335119 A1
(43) Pub. Date: Oct. 22, 2020

(54) SPEECH EXTRACTION USING ATTENTION NETWORK

(71) Applicant: Microsoft Technology Licensing, LLC, Redmond, WA (US)

(72) Inventors: Xiong XIAO, Bothell, WA (US); Zhuo CHEN, Woodinville, WA (US); Takuya YOSHIOKA, Bellevue, WA (US); Changliang LIU, Bothell, WA (US); Hakan ERDOGAN, Sammamish, WA (US); Dimitrios Basile DIMITRIADIS, Bellevue, WA (US); Yifan GONG, Sammamish, WA (US); James Garnet Droppo, III, Carnation, WA (US)

(21) Appl. No.: 16/434,537

(22) Filed: Jun. 7, 2019

Related U.S. Application Data
(60) Provisional application No. 62/834,561, filed on Apr. 16, 2019.

(51) Int. Cl. G10L 21/028; G10L 21/0208

(52) U.S. Cl. CPC G10L 21/028; G10L 2021/02087; G10L 21/0208

(57) ABSTRACT

Embodiments are associated with determination of a first plurality of multi-dimensional vectors, each of the first plurality of multi-dimensional vectors representing speech of a target speaker, determination of a multi-dimensional vector representing a speech signal of two or more speakers, determination of a weighted vector representing speech of the target speaker based on the first plurality of multi-dimensional vectors and on similarities between the multi-dimensional vector and each of the first plurality of multi-dimensional vectors, and extraction of speech of the target speaker from the speech signal based on the weighted vector and the speech signal.

### CROSS-REFERENCE TO RELATED APPLICATIONS

The present application claims the benefit of U.S. Provisional Patent Application No. 62/834,561 filed Apr. 16, 2019, the entire contents of which are incorporated herein by reference for all purposes.

### BACKGROUND

Speech recognition may be used, for example, to automatically transcribe audio signals or recognize speech-based input commands. Such techniques typically assume that a single speaker is speaking at any given time. However, in many real-life scenarios, such as in a meeting or conversation, several speakers may occasionally speak simultaneously.

Conventional speech recognition techniques are unable to satisfactorily perform speech recognition on an audio signal which includes simultaneous, or overlapping, speech. Accordingly, it is desirable to separate the overlapping speech from the audio signal in order to perform speech recognition thereon. This problem is known as speech separation.

According to one type of speech separation, a neural network is trained to receive a mixed speech signal and produce two or more output signals, where each output signal corresponds to only one speaker. For input frames of the mixed speech signal which include no overlapping speech, only one output signal contains speech and the other outputs contain silence. Unfortunately, the order of the speakers in the output signals is arbitrary, necessitating further processing to match the output signals to the speaker identities. Moreover, such approaches do not utilize speaker-specific information, which limits the level of achievable performance.

In another type of speech separation, a neural network receives a mixed speech signal and audio signals of one or more sentences uttered by a target speaker whose speech is to be extracted, and extracts a signal of the target speaker's speech from the mixed speech signal. Accordingly, the identity of the target speaker and the audio signals uttered by the target speaker must be available in advance. Current implementations of this approach are also performance-limited due to a lack of consideration of the speech of competing speakers within the mixed speech signal and/or the coarse usage of the audio signals of one or more sentences uttered by the target speaker. In the latter regard, the uttered audio signals are typically condensed into a single multi-dimensional vector which is used to provide a global bias for extraction of the target speaker's speech from each frame of the input mixed speech signal.

What is needed is a system for improved neural network-based speech separation.

### BRIEF DESCRIPTION OF THE DRAWINGS

FIG. 1 is a block diagram of a system to extract a target speaker's speech from a mixed speech signal according to some embodiments.

FIG. 2 is a flow diagram of a process to extract a target speaker's speech from a mixed speech signal according to some embodiments.

FIG. 3 is a block diagram of a system to extract a target speaker's speech from a mixed speech signal according to some embodiments.

FIG. 4 is a block diagram illustrating similarity weighting of a target speaker bias vector according to some embodiments.

FIG. 5 is a block diagram to illustrate training of a system to extract a target speaker's speech from a mixed speech signal according to some embodiments.

FIG. 6 is a block diagram of a system to extract a target speaker's speech from a mixed speech signal based on a context-dependent target speaker bias vector and a context-dependent competing speaker bias vector according to some embodiments.

FIG. 7 is a flow diagram of a process to extract a target speaker's speech from a mixed speech signal based on a context-dependent target speaker bias vector and a context-dependent competing speaker bias vector according to some embodiments.

FIG. 8 is a block diagram of a system to extract a target speaker's speech from a mixed speech signal based on a context-dependent target speaker bias vector and one or more context-dependent competing speaker bias vectors according to some embodiments.

FIG. 9 is a block diagram to illustrate training of a system to extract a target speaker's speech from a mixed speech signal based on a context-dependent target speaker bias vector and one or more context-dependent competing speaker bias vectors according to some embodiments.

FIG. 10 is a block diagram of a cloud computing system providing meeting transcription according to some embodiments.

FIG. 11 is a block diagram of a system to extract target speech signals from mixed speech signals according to some embodiments.

### DETAILED DESCRIPTION

The following description is provided to enable any person in the art to make and use the described embodiments. Various modifications, however, will remain readily apparent to those of ordinary skill in the art.

Generally, some embodiments perform speech extraction using time-varying and context-dependent target speaker biasing. Contrary to the conventional systems mentioned above, embodiments do not reduce the target speaker bias into a single global vector which is used to guide the extraction of the target speaker's speech from all frames of the input mixed speech signal. Rather, a respective target bias vector may be determined for, and based on, each frame of an input mixed signal in order to extract the target speaker's speech from the respective frames.

Some embodiments may also or alternatively utilize time-varying and context-dependent masks of competing speakers to extract the speech of a target speaker. Generally, a trained network may perform better if provided with information relating to speech to be extracted and information relating to speech which should not be extracted, as opposed to providing only one of these inputs. The vectors/masks/bias signals of the target and/or competing speakers may be determined based on a local similarity between the target/competing profile utterances and the input mixed speech signal, thereby allowing each short time segment of the input mixed speech signal to be aligned and accurately compared with the bias signals.

Embodiments may be compatible with voice-enabled home devices and office meeting transcriptions, in which a possible speaker list and speaker profile signals may be available a priori.

The diagrams described herein do not imply a fixed order to the illustrated methods, and embodiments may be practiced in any order that is practicable. Moreover, any of the methods described herein may be performed by hardware, software, or any combination of these approaches. For example, a computer-readable storage medium may store thereon instructions which when executed by a machine result in performance of methods according to any of the embodiments described herein.

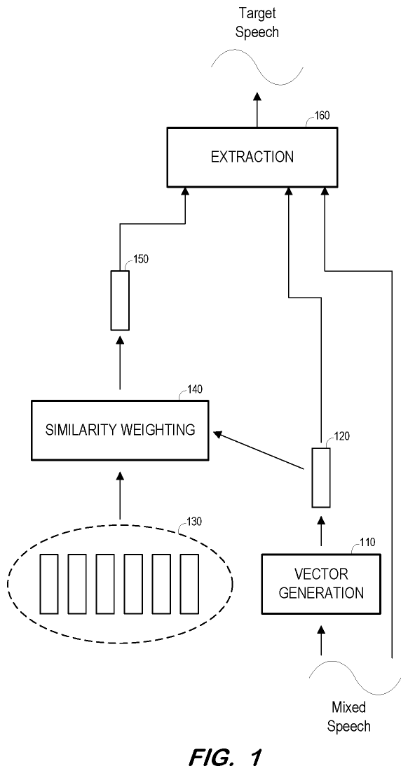

FIG. 1 is a general block diagram illustrating extraction of a target speaker's speech signal from a mixed speech signal according to some embodiments. The process illustrated in FIG. 1 may be implemented using any suitable combinations of hardware and software. Each illustrated function of FIG. 1 or otherwise described herein may be implemented by one or more computing devices (e.g., computer servers), storage devices (e.g., hard or solid-state disk drives), and other hardware as is known in the art. The components may be located remote from one another and may be elements of one or more cloud computing platforms, including but not limited to a Software-as-a-Service, a Platform-as-a-Service, and an Infrastructure-as-a-Service platform. According to some embodiments, one or more components are implemented by one or more dedicated virtual machines.

As shown, vector generation component 110 generates multi-dimensional vector 120 based on a signal representing mixed speech. The signal may include speech of two or more speakers, with at least two speakers speaking simultaneously for at least a portion of the duration of the signal. For simplicity, it will be assumed that vector 120 represents a particular time duration, or frame, of the mixed speech signal.

Vector 120 may comprise a respective value for each of many dimensions which represent characteristics of a portion of the mixed speech signal. Vector 120 may be generated from the mixed speech signal using any system that is or becomes known. Vector generation unit 110 may, in some embodiments, comprise an artificial neural network which has been trained to generate multi-dimensional vectors representing portions of mixed speech signals. An architecture and training of such a network according to some embodiments are described below.

Profile 130 includes a plurality of vectors, each of which represents speech of a target speaker. Each vector of profile 130 may comprise a respective value for each of many dimensions which represent characteristics of a portion of a target speaker's speech. For example, each vector of profile 130 may represent a different portion of any number of recorded sentences of the target speaker's speech. The vectors of profile 130 may be generated using any system that is or becomes known, including a trained artificial neural network as will be described below.

Similarity weighting unit 140 generates bias vector 150 based on vector 120 and the vectors of profile 130. Generally, similarity weighting unit 140 determines a respective similarity between vector 120 and each vector of profile 130. The vectors of profile 130 are then combined based on their determined similarities to vector 120 in order to generate bias vector 150. Determination of the similarities and combination of the vectors of profile 130 based on the similarities according to some embodiments will be described in detail below.

Bias vector 150 therefore represents portions of the target profile vectors which are similar to the mixed speech signal. Bias vector 150, vector 120 and the mixed speech signal are then input to extraction unit 160 to extract a frame of the target speaker's speech signal from the frame of the mixed speech signal represented by vector 120. Extraction unit 160 may also comprise a trained neural network according to some embodiments. In some embodiments, extraction unit 160 generates a Time-Frequency (TF) mask associated with the target speaker and applies the mask to the frame of the mixed speech signal to generate a frame of the target speaker's speech signal.

The foregoing process repeats for a next frame of the mixed speech signal. However, assuming that vector 120 generated based on the next frame differs from the previously-generated vector 120, similarity weighting unit 140 will determine different similarity weightings for each vector of profile 130. Consequently, similarity weighting unit 140 will also generate a different bias vector 150. Bias vector 150 is therefore time-varying and context-dependent. Accordingly, embodiments may provide better information to extraction unit 160 for extraction of a frame of the target speaker's speech than in some prior systems, in which an extraction unit uses a same bias vector to guide extraction of the target speaker's speech from each frame of the mixed speech signal.

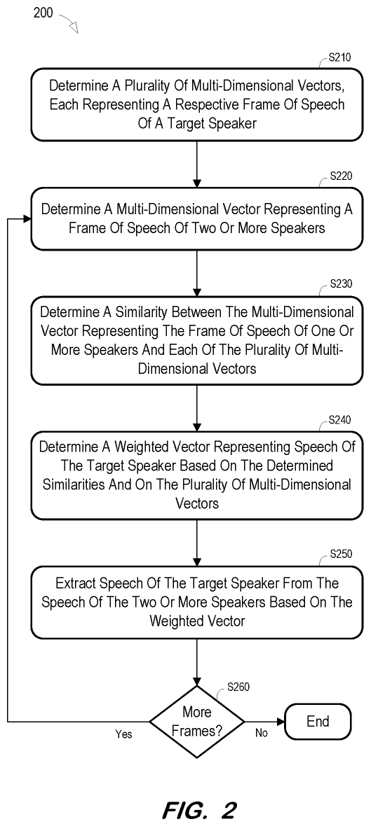

FIG. 2 is a flow diagram of process 200 to extract a target speaker's speech from a mixed speech signal according to some embodiments. Process 200 and the other processes described herein may be performed using any suitable combination of hardware and software. Software program code embodying these processes may be stored by any non-transitory tangible medium, including a fixed disk, a volatile or non-volatile random access memory, a DVD, a Flash drive, or a magnetic tape, and executed by any number of processing units, including but not limited to processors, processor cores, and processor threads. Embodiments are not limited to the examples described below.

Initially, at S210, a plurality of multi-dimensional vectors are determined. Each of the plurality of multi-dimensional vectors represents a respective frame of a target speaker's speech. According to some embodiments, each of the plurality of multi-dimensional vectors may represent a different portion of any number of recorded sentences of the target speaker's speech. S210 may be performed well in advance of the remaining steps of process 200, in a pre-processing phase in which a plurality of multi-dimensional vectors are determined for each of many speakers.

A multi-dimensional vector representing a frame of a speech signal is determined at S220. The speech signal of S220 includes speech of two or more speakers. The speech signal may, for example, comprise an audio recording of a meeting. The multi-dimensional vector may represent features of the frame of the speech signal.

Next, at S230, a similarity is determined between the vector determined at S220 and each vector determined at S210. According to some embodiments, the multi-dimensional vector determined at S220 may be determined using a same network or algorithm as used to determine each multi-dimensional vector at S210. Such determinations may facilitate the similarity determinations at S230.

A weighted vector representing speech of the target speaker is determined at S240. The weighted vector is determined based on the vectors determined at S210 and on the similarities determined for each of these vectors at S230. For example, it is assumed that a first one of the plurality of vectors determined at S210 is determined to be very similar to the vector determined at S220, and a second one of the plurality of vectors determined at S210 is determined to be less similar to the vector determined at S220. Accordingly, the first vector will be weighted more heavily than the second vector in the determination of the weighted vector at S240. Consequently, the weighted vector will be more similar to the first vector than to the second vector.

At S250, speech of the target speaker is extracted from the frame of speech of the two or more speakers based on the weighted vector. According to some embodiments, the weighted vector and the vector determined at S220 are used at S250 to extract a frame of the target speaker's speech.

It is then determined at S260 whether additional frames of speech of the two or more speakers remain to be processed. If so, flow returns to S220 to determine a multi-dimensional vector representing the next frame of speech of the two or more speakers. New similarities are determined S230 between the next frame and each of the plurality of vectors determined at S210. These new similarities are used in conjunction with each of the plurality of vectors to determine a new weighted vector at S240 which is used at S250 to extract a frame of the target speaker's speech from the next frame of speech.

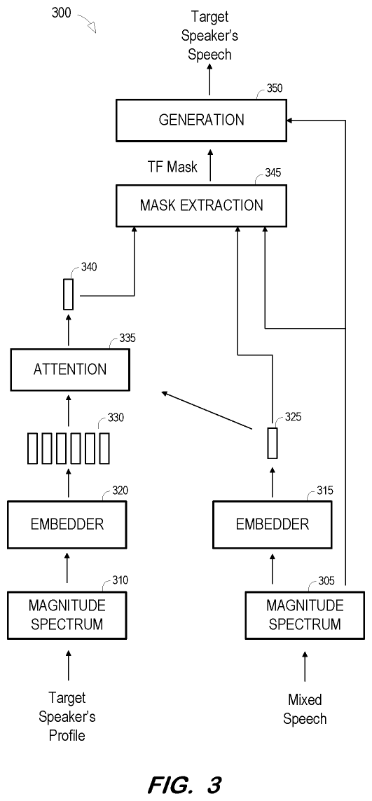

FIG. 3 is a block diagram illustrating extraction of a target speaker's speech from a mixed speech signal according to some embodiments. FIG. 3 may comprise an implementation of the FIG. 1 or FIG. 2 processes, but embodiments are not limited thereto.

According to the extraction depicted in FIG. 3, a frame of a mixed speech signal is input to magnitude spectrum unit 305 to generate a log-scaled magnitude spectrum representing the frame of the mixed speech signal. Similarly, frames of a target speaker's profile are input to magnitude spectrum unit 310 to generate a log-scaled magnitude spectrum for each frame of the target speaker's profile. According to some embodiments, the log-scaled magnitude spectrum of a frame consists of 257 dimensions.

The log-scaled magnitude spectra of the frame of mixed speech and the frames of target speech are input to embedders 315 and 320, respectively. Embodiments may employ any suitable audio representations for input to embedders 315 and 320. Based on the input, embedder 315 and embedder 320 respectively generate embedding vector 325 and embedding vectors 330. As is known in the art, the embedding vectors may be projected from the hidden activations of a last layer of a trained neural network implementing embedders 315 and 320. Each embedding vector may consist of 512 dimensions, but embodiments are not limited to the particular dimensionalities noted herein.

As described with respect to similarity weighting unit 140 of FIG. 1, attention network 335 determines a similarity between embedding vector 325 and each of embedding vectors 330 and generates bias vector 340 based on the determined similarities. According to some embodiments, attention network 335 generates bias vector 340 by combining embedding vectors 330 in a manner which gives more weight to the vectors of the target speaker's frames that are more similar to the current mixed speech frame. Accordingly, a particular generated bias vector will exhibit a phonetic/acoustic context which is more similar to the particular mixed speech frame from which the target speaker's speech will be extracted using the particular bias vector.

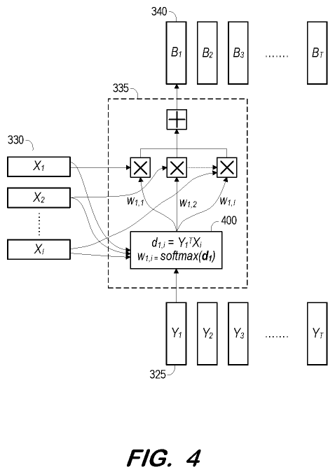

FIG. 4 is a block diagram illustrating operation of attention network 335 according to some embodiments. According to some embodiments, the target speaker's profile signals and the mixed speech signal are input to embedders 320 and 315, respectively, resulting in matrix X∈R^{D×T}^{_{S}} of target embedding vectors and matrix Y∈R^{D×T}^{ₘ} of mixed embedding vectors, where D is the dimension of the embedding vectors, and Tₛ and Tₘ are the number of frames of the target speaker's profile audio signals and the mixed speech signal, respectively.

Attention network 335 computes context-dependent bias vectors B∈R^{D×T}^{ₘ} from X∈R^{D×T}^{_{S}} and Y∈R^{D×T}^{ₘ} as follows:

$${B}_{t} = {\sum }_{i = 1}^{{T}_{s}} {w}_{t , i} {X}_{i} \\ {w}_{t , i} = \frac{exp ( {d}_{t , i} )}{{\sum }_{j = 1}^{{T}_{s}} exp ( {d}_{t , j} )} \\ {d}_{t , i} = {Y}_{t}^{T} {X}_{i} ,$$

where d_{t,i} is the inner product of Yₜ and Xᵢ and measures their similarity, the weight w_{t,i} is the softmax of d_{t,i} over i∈[1, T], and the bias vector at frame t is Bₜ. Bₜ is therefore a weighted sum of embedding vectors 330 of the target speaker's profile data.

Mask extraction unit 345 receives vectors 325 and 340 and the mixed speech signal and generates a TF mask of the target speaker's speech based thereon. Mask extraction unit 345 may comprise a trained neural network as will be described below. Generation unit 350 applies the TF mask to the subject frame of the mixed speech signal as is known in the art in order to output an extracted frame of the target speaker's speech.

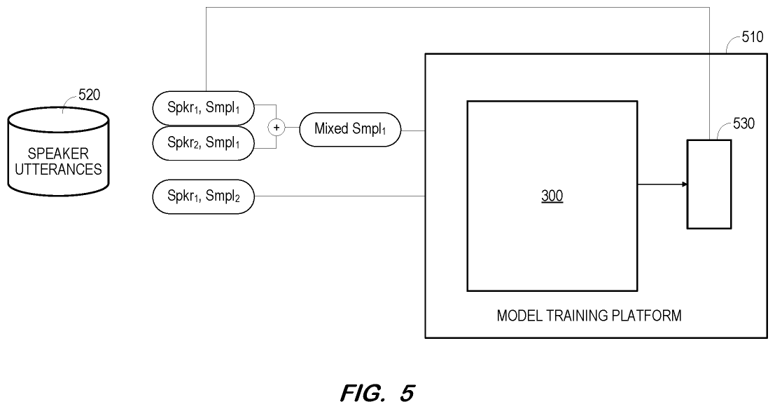

FIG. 5 illustrates training of a system to extract a target speaker's speech from a mixed speech signal according to some embodiments. Model training platform 510 may comprise any suitable system to instantiate and train one or more artificial neural networks of any type. In the present example, model training platform 510 implements system 300 of FIG. 3. Training of system 300 is not limited to the details (e.g., training data, network architectures) of the examples described herein.

Generally, model training platform 510 operates to input training data to system 300, determine whether the resulting output of system 300 is sufficiently accurate with respect to ground truth data, modify system 300 if the resulting output of system 300 is not sufficiently accurate, and repeat the process until the resulting output of system 300 is sufficiently accurate.

According to some embodiments, the training data is determined based on speech signals stored in datastore 520. Datastore 520 associates each of a plurality of speakers with one or more pre-captured utterances. The utterances may be audio signals in any format suitable for input to system 300.

In one non-exhaustive example illustrated in FIG. 5, two speakers are randomly selected from the speakers of datastore 520. For each of the two speakers (e.g., Spkr₁, Spkr₂), an utterance longer than a minimum length (e.g., 5 s) is randomly sampled. The two utterances ((Spkr₁, Smpl₁), (Spkr₂, Smpl₁)) are mixed using a uniformly-sampled signal-to-interference ratio, with the length of the mixed speech sample (Mixed Smpl₁) being equal to the length of the longer source utterance and the starting point of the shorter source utterance being randomly determined.

A target profile utterance of one of the randomly-selected speakers is also randomly sampled. The target profile utterance (e.g., Spkr₁, Smpl₂) is longer than a minimum length (e.g., 10 s) and is different from the utterance used for generating the mixed speech. The mixed speech sample and the target profile utterance comprise a single training sample. A training set may consist of thousands of such training samples, each generated as described above.

As shown, the mixed speech sample and target profile utterance of a training sample are input to model training platform 510 for input to system 300. Loss component 530 then determines a difference between the output of system 300 and the utterance of the target speaker which was used to generate the mixed speech sample (e.g., (Spkr₁, Smpl₁)). The above is repeated for each training sample of the training set, in order to determine an overall loss. Model training platform 510 then modifies the neural networks of system 300 based on the overall loss as is known in the. The foregoing process may be considered a single training steps, and training may include the execution of thousands of successive steps.

According to some embodiments, the input mixed speech sample and the input target speaker profile each comprise a 257 dimension log-scaled magnitude spectrum. Each analysis frame may be 32 ms long (e.g., 512 samples for a sampling rate of 16 kHz) and successive frames may be shifted by 16 ms. The FFT length is 512.

In some embodiments, the same embedding network is used as embedder 320 and embedder 315 to generate the embedding vectors for the target speaker profile and the mixed speech signal. The embedding network may include two bidirectional Long Short-Term Memory (BLSTM) layers, with 512 cells in each direction of each layer. As is known in the art, the last layer's hidden activations are projected to 512 dimension embedding vectors.

An extraction network implementing mask extraction component 345 may contain two BLSTM layers, each with 512 cells in each direction of each layer. The input dimension of mask extraction component 345 is 257+512*2, and the output comprises TF masks of 257 dimensions.

A neural network (e.g., deep learning, deep convolutional, or recurrent) according to some embodiments comprises a series of “neurons,” such as Long Short-Term Memory (LSTM) nodes, arranged into a network. A neuron is an architecture used in data processing and artificial intelligence, particularly machine learning, that includes memory that may determine when to “remember” and when to “forget” values held in that memory based on the weights of inputs provided to the given neuron. Each of the neurons used herein are configured to accept a predefined number of inputs from other neurons in the network to provide relational and sub-relational outputs for the content of the frames being analyzed. Individual neurons may be chained together and/or organized into tree structures in various configurations of neural networks to provide interactions and relationship learning modeling for how each of the frames in an utterance are related to one another.

For example, an LSTM serving as a neuron includes several gates to handle input vectors, a memory cell, and an output vector. The input gate and output gate control the information flowing into and out of the memory cell, respectively, whereas forget gates optionally remove information from the memory cell based on the inputs from linked cells earlier in the neural network. Weights and bias vectors for the various gates are adjusted over the course of a training phase, and once the training phase is complete, those weights and biases are finalized for normal operation. Neurons and neural networks may be constructed programmatically (e.g., via software instructions) or via specialized hardware linking each neuron to form the neural network.

According to the foregoing embodiments, the TF masks are multiplied by the linear magnitude of the mixed speech to signal to generate the extracted magnitude of the target speaker's speech. This extracted magnitude is compared against the target speaker's source speech used to generate the mixed speech signal in order to determine the training loss. According to some embodiments, the networks are trained with the Adam optimizer jointly to minimize the mean squared error between the extracted magnitude of the target speaker's speech and the magnitude of the target speaker's source speech.

It may be difficult to differentiate the target and competing speakers, particularly when a competing speaker's voice is similar to that of the target speaker. In these situations and others, it may be beneficial to use a competing speaker's profile to assist the extraction process. By providing the extraction network with information representing the target speech and speech which should not be extracted, the extraction network may be better able to extract the target speech.

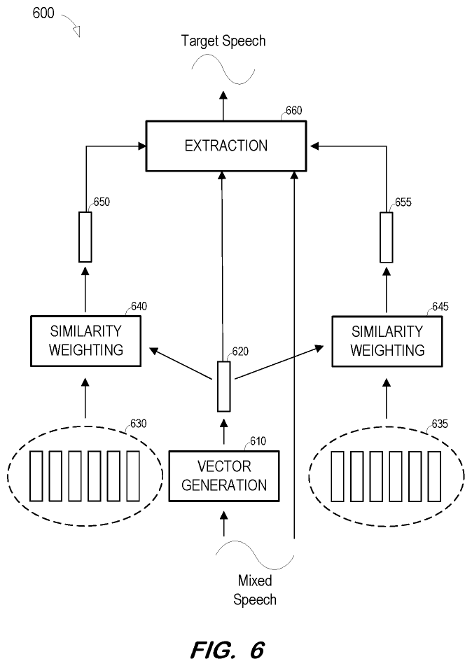

FIG. 6 is a block diagram of a system to extract a target speaker's speech from a mixed speech signal based on a context-dependent target speaker bias vector and a context-dependent competing speaker bias vector according to some embodiments.

Similar to the description of FIG. 1, vector generation component 510 generates multi-dimensional vector 620 representing a frame of a signal including mixed speech. The signal may include speech of two or more speakers, one of whom is the target speaker and at least one of whom is a known competing speaker.

Profile 630 includes a plurality of multi-dimensional vectors, each of which represents a frame of speech of the target speaker. Profile 635 also includes a plurality of multi-dimensional vectors, each of which represents a frame of speech of the known competing speaker.

Similarity weighting unit 640 generates bias vector 650 based on vector 620 and the vectors of profile 530 as described above. Moreover, similarity weighting unit 645 generates bias vector 655 based on vector 620 and the vectors of profile 635 as described above. Accordingly, bias vector 650 represents portions of target profile vectors 530 which are similar to the subject frame of the mixed speech signal and bias vector 655 represents portions of competing speaker profile vectors 635 which are similar to the subject frame of the mixed speech signal.

Vector 620, bias vector 650, bias vector 655 and the mixed speech signal are then input to extraction unit 660 to extract a frame of the target speaker's speech signal from the subject frame of the mixed speech signal. As described above, extraction unit 660 generates a TF mask associated with the target speaker and applies the mask to the frame of the mixed speech signal to generate a frame of the target speaker's speech signal. In some embodiments, extraction unit 660 may also generate a TF mask associated with the competing speaker.

The foregoing process repeats for a next frame of the mixed speech signal. Consequently, similarity weighting unit 640 generates a different bias vector 650 and similarity weighting unit 645 generates a different bias vector 655 corresponding to the vector 620 generated based on the next frame. Bias vectors 650 and 655 are therefore both time-varying and context-dependent.

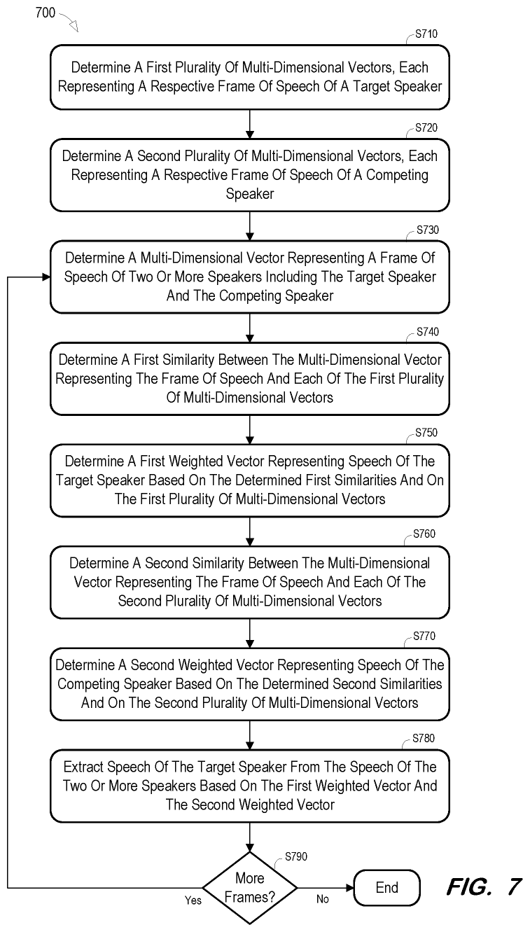

FIG. 7 is a flow diagram of process 700 to extract a target speaker's speech from a mixed speech signal based on a target speaker profile and a competing speaker profile according to some embodiments. Process 700 may be implemented by system 600 in some embodiments.

Prior to process 700, a mixed speech signal is identified from which a target speaker's speech is to be extracted. The target speaker and a competing speaker whose speech is also present in the mixed speech signal are also identified.

A first plurality of multi-dimensional vectors are determined at S710, with each of the first plurality of multi-dimensional vectors representing a respective frame of a target speaker's speech. According to some embodiments, each of the plurality of multi-dimensional vectors may represent a different portion of any number of recorded sentences of the target speaker's speech. A second plurality of multi-dimensional vectors are determined at S720, with each of the second plurality of multi-dimensional vectors representing a respective frame of the competing speaker's speech. According to some embodiments, each of the plurality of multi-dimensional vectors may represent a different portion of any number of recorded sentences of the target speaker's speech. S710 and S720 may be performed during a pre-processing phase in which a plurality of multi-dimensional vectors are determined for each of many speakers.

A multi-dimensional vector representing a frame of a mixed speech signal is determined at S730. The speech signal includes speech of the target speaker, the competing speaker, and zero or more additional speakers. Next, at S740, a similarity is determined between the vector determined at S730 and each of the first plurality of vectors determined at S710. A first weighted vector is determined at S750 based on the first plurality of vectors determined at S710 and on the similarities determined for each of these vectors at S740, as described with respect to S240 and FIG. 4.

As depicted in FIG. 6, a similarity is also determined at S760 between the vector determined at S730 and each of the second plurality of vectors determined at S720. A second weighted vector is determined at S770 based on the second plurality of vectors and on the similarities determined for each of these vectors at S760, also as described with respect to S240 and FIG. 4.

At S780, speech of the target speaker is extracted from the frame of speech of the two or more speakers based on the first weighted vector and the second weighted vector. According to some embodiments, and as illustrated in FIG. 6, the extraction at S780 is based on the first weighted vector, the second weighted vector, the vector determined at S730 and on the mixed speech signal itself.

Flow returns to S720 if it is determined at S790 that a next frame of speech of the two or more speakers is to be processed. Re-execution of these steps results in the determination of new similarities at S740 and S760 and resulting new first and second weighted vectors. These new first and second weighted vectors are then used to extract a frame of the target speaker's speech from the next frame of mixed speech.

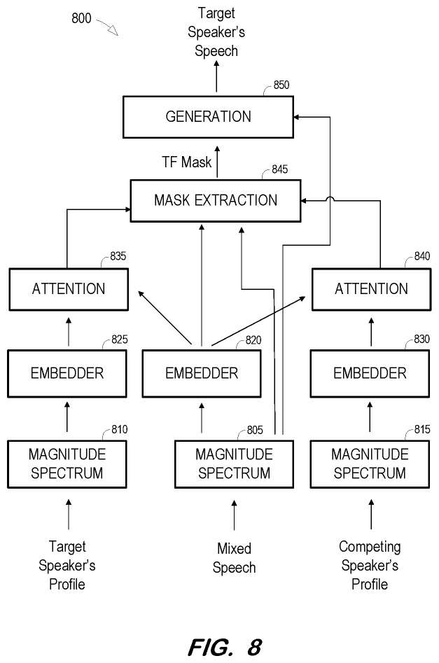

FIG. 8 is a block diagram illustrating extraction of a target speaker's speech from a mixed speech signal using the target speaker's profile and a competing speaker's profile according to some embodiments. FIG. 8 may comprise an implementation of system 600 or process 700, but embodiments are not limited thereto.

A frame of a mixed speech signal is input to magnitude spectrum unit 805 to generate a log-scaled magnitude spectrum representing the frame of the mixed speech signal. The mixed speech signal may include speech of a known target speaker and a known competing speaker. Frames of the target speaker's profile are input to magnitude spectrum unit 810 to generate a log-scaled magnitude spectrum for each frame of the target speaker's profile, and frames of the competing speaker's profile are input to magnitude spectrum unit 815 to generate a log-scaled magnitude spectrum for each frame of the competing speaker's profile. As mentioned above, the log-scaled magnitude spectrum of a frame may consist of 257 dimensions.

The log-scaled magnitude spectra of the frame of mixed speech, the frames of the target speaker's profile and the frames of the competing speaker's profile are input to embedders 820, 825 and 830, respectively. Embedder 820 generates an embedding vector representing the mixed speech signal, embedder 825 generates embedding vectors of the target speaker's profile, and embedder 830 generates embedding vectors of the competing speaker's profile.

Attention network 835 generates a target bias vector based on a similarity between the embedding vector generated by embedder 820 and each of the embedding vectors generated by embedder 825. Attention network 835 may generate the bias vector by combining the embedding vectors generated by embedder 825 in a manner which gives more weight to the vectors of the target speaker's frames that are more similar to the current mixed speech frame.

Similarly, attention network 840 generates a competing bias vector based on a similarity between the embedding vector generated by embedder 820 and each of the embedding vectors generated by embedder 830. Attention network 840 may also generate the bias vector by combining the embedding vectors generated by embedder 830 in a manner which gives more weight to the vectors of the competing speaker's frames that are more similar to the current mixed speech frame.

Mask extraction unit 845 receives weighted vectors from attention networks 835 and 840, the embedding vector of generated by embedder 820, and the log-scaled magnitude spectrum of the mixed speech frame. The received vectors may be concatenated in some embodiments. Mask extraction unit 845 generates a TF mask of the target speaker's speech and, in some embodiments and based on the training thereof, may also generate a TF mask of the competing speaker's speech. Generation unit 850 then applies the TF mask to the subject frame of the mixed speech signal to output an extracted frame of the target speaker's speech.

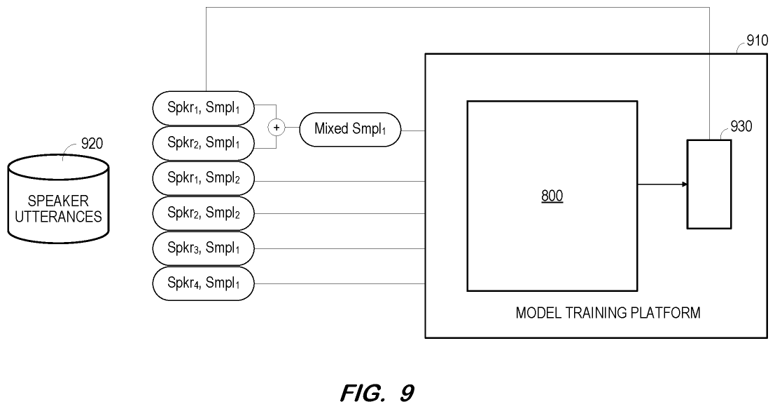

FIG. 9 illustrates training of a system to extract a target speaker's speech from a mixed speech signal based on a context-dependent target speaker bias vector and one or more context-dependent competing speaker bias vectors according to some embodiments.

Model training platform 510 may operate to input training data to system 800 of FIG. 8, determine whether the resulting output of system 800 is sufficiently accurate with respect to ground truth data, modify system 800 if the resulting output of system 800 is not sufficiently accurate, and repeat the process until the resulting output of system 800 is sufficiently accurate.

FIG. 9 also illustrates the determination of training data for platform 910 based on speech signals stored in datastore 920. For each of two randomly-selected speakers (e.g., Spkr₁, Spkr₂), an utterance longer than a minimum length (e.g., 5 s) is randomly sampled. The two utterances ((Spkr₁, Smpl₁), (Spkr₂, Smpl₁)) are mixed using a uniformly-sampled signal-to-interference ratio, with the length of the mixed speech sample (Mixed Smpl1) being equal to the length of the longer source utterance and the starting point of the shorter source utterance being randomly determined.

Profile utterances of each of the two randomly-selected speakers are also randomly sampled. The profile utterances (e.g., (Spkr₁, Smpl₂), (Spkr₂, Smpl₂)) are longer than a minimum length (e.g., 10 s) and are different from the utterances used for generating the mixed speech. As shown in FIG. 9, the training set also includes randomly-sampled utterances of two other randomly-sampled speakers (e.g., (Spkr₃, Smpl₁), (Spkr₄, Smpl₁)). These utterances may be used as extra competing speakers that do not contribute to the mixed speech.

For each input training set, loss component 930 determines a difference between the output of system 800 and the utterance of the target speaker which was used to generate the mixed speech sample (e.g., (Spkr₁, Smpl₁)). The above is repeated for each training sample of the training set, in order to determine an overall loss.

In some embodiments, the same embedding network is used as embedder 820, embedder 825 and embedder 830 to generate the embedding vectors for the target speaker profile, the mixed speech signal and the competing speaker profile. The input dimension of mask extraction component 845 may therefore be 257+512*3, and the output comprises TF masks of 257 dimensions.

According to some embodiments, only a competing speaker's profile is used to extract speech of a target speaker. For example, a bias vector is generated for each frame of input mixed speech based on vectors representing a competing speaker's profile, and this bias vector is used to extract the target speaker's speech. Such an embodiment may be implemented by a system similar to system 600, but omitting elements 630, 640 and 650, a process similar to process 700 but omitting steps S710, S740 and S750, or a system similar to system 800 but omitting elements 810, 825 and 835.

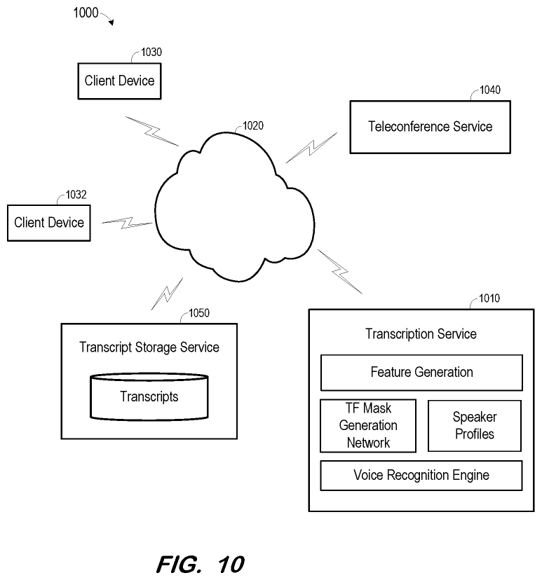

FIG. 10 illustrates distributed transcription system 1000 according to some embodiments. System 1000 may be cloud-based and components thereof may be implemented using on-demand virtual machines, virtual servers and cloud storage instances.

As shown, transcription service 1010 may be implemented as a cloud service providing transcription of mixed speech audio signals received over cloud 1020. Transcription service 1010 may implement target speaker speech extraction according to some embodiments.

Each of client devices 1030 and 1032 may be operated by a participant in a teleconference managed by cloud teleconference service 1040. Teleconference service 1040 may provide mixed speech audio signals of the meeting and, in some embodiments, a list of meeting participants, to transcription service 1010. Transcription service 1010 may operate according to some embodiments to extract speech of target speakers from the mixed speech signal and perform voice recognition on the extracted signals to generate a transcript of the teleconference. Transcription service 1010 may in turn access transcript storage service 1050 to store the generated transcript. Either of client devices 1030 and 1032 may then access transcript storage service 1050 to request a stored transcript.

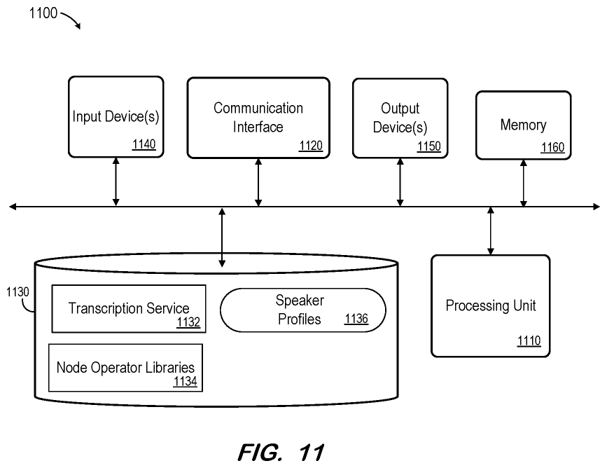

FIG. 11 is a block diagram of system 1100 according to some embodiments. System 1100 may comprise a general-purpose server computer and may execute program code to provide a transcription service and/or speech extraction service as described herein. System 1100 may be implemented by a cloud-based virtual server according to some embodiments.

System 1100 includes processing unit 1110 operatively coupled to communication device 1120, persistent data storage system 1130, one or more input devices 1140, one or more output devices 1150 and volatile memory 1160. Processing unit 1110 may comprise one or more processors, processing cores, etc. for executing program code. Communication interface 1120 may facilitate communication with external devices, such as client devices, and data providers as described herein. Input device(s) 1140 may comprise, for example, a keyboard, a keypad, a mouse or other pointing device, a microphone, a touch screen, and/or an eye-tracking device. Output device(s) 1150 may comprise, for example, a display (e.g., a display screen), a speaker, and/or a printer.

Data storage system 1130 may comprise any number of appropriate persistent storage devices, including combinations of magnetic storage devices (e.g., magnetic tape, hard disk drives and flash memory), optical storage devices, Read Only Memory (ROM) devices, etc. Memory 1160 may comprise Random Access Memory (RAM), Storage Class Memory (SCM) or any other fast-access memory.

Transcription service 1132 may comprise program code executed by processing unit 1110 to cause system 1100 to receive mixed speech signals and extract one or more target speaker's speech signals therefrom as described herein. Node operator libraries 1134 may comprise program code to execute functions of trained nodes of a neural network to generate TF masks as described herein. Speaker profiles 1136 may include utterances and/or embedding vectors representing profiles of one or more speakers. Data storage device 1130 may also store data and other program code for providing additional functionality and/or which are necessary for operation of system 1100, such as device drivers, operating system files, etc.

Each functional component described herein may be implemented at least in part in computer hardware, in program code and/or in one or more computing systems executing such program code as is known in the art. Such a computing system may include one or more processing units which execute processor-executable program code stored in a memory system.

The foregoing diagrams represent logical architectures for describing processes according to some embodiments, and actual implementations may include more or different components arranged in other manners. Other topologies may be used in conjunction with other embodiments. Moreover, each component or device described herein may be implemented by any number of devices in communication via any number of other public and/or private networks. Two or more of such computing devices may be located remote from one another and may communicate with one another via any known manner of network(s) and/or a dedicated connection. Each component or device may comprise any number of hardware and/or software elements suitable to provide the functions described herein as well as any other functions. For example, any computing device used in an implementation of a system according to some embodiments may include a processor to execute program code such that the computing device operates as described herein.

All systems and processes discussed herein may be embodied in program code stored on one or more non-transitory computer-readable media. Such media may include, for example, a hard disk, a DVD-ROM, a Flash drive, magnetic tape, and solid state Random Access Memory (RAM) or Read Only Memory (ROM) storage units. Embodiments are therefore not limited to any specific combination of hardware and software.

Those in the art will appreciate that various adaptations and modifications of the above-described embodiments can be configured without departing from the claims. Therefore, it is to be understood that the claims may be practiced other than as specifically described herein.

What is claimed is:

1. A system comprising:
a processing unit; and
a memory storage device including program code that when executed by the processing unit enables the system to:
determine a first plurality of multi-dimensional vectors, each of the first plurality of multi-dimensional vectors representing a respective frame of speech of a target speaker;
determine a multi-dimensional vector representing a frame of a speech signal of two or more speakers;
determine a similarity between the multi-dimensional vector and each of the first plurality of multi-dimensional vectors;
determine a weighted vector representing speech of the target speaker based on the determined similarities and on the first plurality of multi-dimensional vectors; and
determine an extracted frame of speech of the target speaker based on the weighted vector and the frame of the speech signal of two or more speakers.

2. The system of claim 1, wherein the extracted frame of speech of the target speaker is determined based on the weighted vector, the multi-dimensional vector representing a frame of a speech signal, and the frame of the speech signal.

3. The system of claim 1, the program code when executed by the processing unit enables the system to:
determine a second plurality of multi-dimensional vectors, each of the second plurality of multi-dimensional vectors representing a respective frame of speech of a competing speaker;
determine a similarity between the multi-dimensional vector and each of the second plurality of multi-dimensional vectors; and
determine a second weighted vector representing speech of the competing speaker based on the determined similarities between the multi-dimensional vector and each of the second plurality of multi-dimensional vectors, and on the second plurality of multi-dimensional vectors,
wherein the extracted frame of speech of the target speaker is determined based on the weighted vector, the second weighted vector, and the frame of the speech signal of two or more speakers.

4. The system of claim 3, wherein the extracted frame of speech of the target speaker is determined based on the weighted vector, the second weighted vector, the multi-dimensional vector representing a frame of a speech signal, and the frame of the speech signal.

5. The system of claim 4, the program code when executed by the processing unit enables the system to:
determine a second multi-dimensional vector representing a second frame of the speech signal of two or more speakers;
determine a similarity between the second multi-dimensional vector and each of the first plurality of multi-dimensional vectors;
determine a third weighted vector representing speech of the target speaker based on the determined similarities between the second multi-dimensional vector and each of the first plurality of multi-dimensional vectors, and on the first plurality of multi-dimensional vectors;
determine a similarity between the second multi-dimensional vector and each of the second plurality of multi-dimensional vectors;
determine a fourth weighted vector representing speech of the target speaker based on the determined similarities between the second multi-dimensional vector and each of the second plurality of multi-dimensional vectors, and on the second plurality of multi-dimensional vectors; and
determine a second extracted frame of speech of the target speaker based on the third weighted vector, the fourth weighted vector, and the frame of the speech signal of two or more speakers,
wherein the third weighted vector is different from the weighted vector and the fourth weighted vector is different from the second weighted vector.

6. The system of claim 1, wherein a contribution of one of the first plurality of multi-dimensional vectors to the weighted vector is directly proportional to the similarity of the one of the first plurality of multi-dimensional vectors to the multi-dimensional vector representing the frame of the speech signal.

7. The system of claim 1, the program code when executed by the processing unit enables the system to:
determine a second multi-dimensional vector representing a second frame of the speech signal of two or more speakers;
determine a similarity between the second multi-dimensional vector and each of the first plurality of multi-dimensional vectors;
determine a second weighted vector representing speech of the target speaker based on the determined similarities between the second multi-dimensional vector and each of the first plurality of multi-dimensional vectors, and on the first plurality of multi-dimensional vectors; and
determine a second extracted frame of speech of the target speaker based on the second weighted vector and the frame of the speech signal of two or more speakers,
wherein the second weighted vector is different from the weighted vector.

8. A computer-implemented method comprising:
determining a first plurality of multi-dimensional vectors, each of the first plurality of multi-dimensional vectors representing speech of a target speaker;
determining a multi-dimensional vector representing a speech signal of two or more speakers;
determining a weighted vector representing speech of the target speaker based on the first plurality of multi-dimensional vectors and on similarities between the multi-dimensional vector and each of the first plurality of multi-dimensional vectors; and
extracting speech of the target speaker from the speech signal based on the weighted vector and the speech signal.

9. The method of claim 8, wherein the speech of the target speaker is extracted from the speech signal based on the weighted vector, the multi-dimensional vector representing the speech signal, and the speech signal.

10. The method of claim 1, further comprising:
determining a second plurality of multi-dimensional vectors, each of the second plurality of multi-dimensional vectors representing speech of a competing speaker; and
determining a second weighted vector representing speech of the competing speaker based on the second plurality of multi-dimensional vectors and on similarities between the multi-dimensional vector and each of the second plurality of multi-dimensional vectors,
wherein the speech of the target speaker is extracted based on the weighted vector, the second weighted vector, and the speech signal.

11. The method of claim 10, wherein the speech of the target speaker is extracted based on the weighted vector, the second weighted vector, the multi-dimensional vector representing a frame of a speech signal, and the speech signal.

12. The method of claim 11, further comprising:
determining a second multi-dimensional vector representing the speech signal;
determining a third weighted vector representing speech of the target speaker based on the first plurality of multi-dimensional vectors and on similarities between the second multi-dimensional vector and each of the first plurality of multi-dimensional vectors;
determining a fourth weighted vector representing speech of the target speaker based on the second plurality of multi-dimensional vectors and on similarities between the second multi-dimensional vector and each of the second plurality of multi-dimensional vectors; and
extracting a second speech of the target speaker based on the third weighted vector, the fourth weighted vector, and the speech signal,
wherein the third weighted vector is different from the weighted vector and the fourth weighted vector is different from the second weighted vector.

13. The method of claim 8, wherein a contribution of one of the first plurality of multi-dimensional vectors to the weighted vector is directly proportional to the similarity of the one of the first plurality of multi-dimensional vectors to the multi-dimensional vector representing the speech signal.

14. The method of claim 8, further comprising:
determining a second multi-dimensional vector representing the speech signal;
determining a second weighted vector representing speech of the target speaker based on the first plurality of multi-dimensional vectors and similarities between the second multi-dimensional vector and each of the first plurality of multi-dimensional vectors; and
extracting a second extracted frame of speech of the target speaker based on the second weighted vector and the speech signal,
wherein the second weighted vector is different from the weighted vector.

15. A non-transient, computer-readable medium storing program code to be executed by a processing unit to provide:
an embedder network to determine a first plurality of multi-dimensional vectors based on respective frames of speech of a target speaker, and to determine a multi-dimensional vector representing a frame of a speech signal of two or more speakers including the target speaker;
an attention network to determine a similarity between the multi-dimensional vector and each of the first plurality of multi-dimensional vectors, and to determine a weighted vector representing speech of the target speaker based on the determined similarities and on the first plurality of multi-dimensional vectors; and
an extraction network to extract a frame of speech of the target speaker from the speech signal based on the weighted vector and the frame of the speech signal of two or more speakers.

16. The medium of claim 15,
the embedder network to determine a second plurality of multi-dimensional vectors based on respective frames of speech of a competing speaker of the two or more speakers,
the attention network to determine a similarity between the multi-dimensional vector and each of second plurality of multi-dimensional vectors, and to determine a second weighted vector representing speech of the competing speaker based on the determined similarities between the multi-dimensional vector and each of second plurality of multi-dimensional vectors and on the second plurality of multi-dimensional vectors, and
the extraction network to extract the frame of speech of the target speaker based on the weighted vector, the second weighted vector, and the frame of the speech signal of two or more speakers.

17. The medium of claim 16,
the embedder network to determine a second multi-dimensional vector representing a second frame of the speech signal of two or more speakers,
the attention network to determine a similarity between the second multi-dimensional vector and each of the first plurality of multi-dimensional vectors, to determine a third weighted vector representing speech of the target speaker based on the determined similarities between the second multi-dimensional vector and each of the first plurality of multi-dimensional vectors, and on the first plurality of multi-dimensional vectors, to determine a similarity between the second multi-dimensional vector and each of the second plurality of multi-dimensional vectors, and to determine a fourth weighted vector representing speech of the competing speaker based on the determined similarities between the second multi-dimensional vector and each of the second plurality of multi-dimensional vectors, and on the second plurality of multi-dimensional vectors, and
the extraction network to extract a second frame of speech of the target speaker based on the third weighted vector, the fourth weighted vector, and the frame of the speech signal of two or more speakers,
wherein the third weighted vector is different from the weighted vector and the fourth weighted vector is different from the second weighted vector.

18. The medium of claim 15,
the embedder network to determine a second multi-dimensional vector representing a second frame of the speech signal of two or more speakers,
the attention network to determine a similarity between the second multi-dimensional vector and each of the first plurality of multi-dimensional vectors, to determine a second weighted vector representing speech of the target speaker based on the determined similarities between the second multi-dimensional vector and each of the first plurality of multi-dimensional vectors, and on the first plurality of multi-dimensional vectors, and
the extraction network to extract a second frame of speech of the target speaker based on the weighted vector, the second weighted vector, and the second frame of the speech signal of two or more speakers,
wherein the second weighted vector is different from the weighted vector.
